(19) United States
(12) Patent Application Publication
(10) Pub. No.: US 2020/0320893 A1
(43) Pub. Date: Oct. 8, 2020

(54) TUTOR RATING FOR BROKERED TUTOR MATCHING

(71) Applicant: THE OTHER RIGHT, LLC, Miami, FL (US)

(72) Inventors: James Nicolo Bates, Miami, FL (US); Eduardo Burillo, Miami, FL (US)

(21) Appl. No.: 16/374,711

(22) Filed: Apr. 3, 2019

(51) Int. Cl. G09B 5/14; G06F 16/9536; G06Q 50/20; G06Q 10/06

(52) U.S. Cl. CPC G09B 5/14; G06Q 10/06398; G06Q 50/20; G06F 16/9536

(57) ABSTRACT

A method for tutor rating for brokered tutor matching includes receiving a tutoring request for tutoring services from a student registered for a selection of courses at an academic institution, the request specifying a course, a time of tutoring and duration of tutoring. Thereafter, a set of tutors is identified, each having been registered to perform tutoring in the specified course as having previously completed coursework in the specified course and having achieved a threshold grade in the specified course. A rating for each one of the tutors in the set is then retrieved and the student matched with a highest rated one of the tutors in the set. Finally, the matched tutor is assigned to the student as a tutor providing the tutoring services at the time of tutoring.

### BACKGROUND OF THE INVENTION

### Field of the Invention

The present invention relates to the field of on-line scheduling and more particularly to the coordination of a student tutoring session.

### Description of the Related Art

The process of classroom education refers to the attendance by a student in a class instructed by a teacher within a classroom environment at an educational institution. Traditional classroom education involves the delivery of one or more classroom lectures, roundtable discussions or laboratories on a fixed schedule according to a syllabus with one or more graded examinations administered throughout. In so far as the material instructed during a classroom session may be of such density so as to required additional instruction, in many instances, additional private sessions with the instructor may be attended by a student in the form of “office hours”. As well, to the extent that the office hours are not sufficient to service the instructional needs of all students, for many courses, teaching assistants are enlisted to provide additional instruction also in the form of office hours, or alternatively in a group attended additionally scheduled class.

Despite opportunities afforded by classroom instruction and office hours in the academic session, oftentimes, for many students, more personalized attention is required. To that end, in most academic environments, private and small-group tutoring services may be offered, either as an offering of the academic institution, an offering that is separate from but coordinated by the academic institution, or as a third party offering without coordination with the academic institution. In the former instance, the academic institution may allocate space in the physical plant of the campus and hire or contract one or more tutors to be present during certain defined hours within the physical plant. In the latter circumstance, individual, enterprising students may advertise available tutoring services through campus media, printed flyers, online advertising, or by word of mouth. Notwithstanding, the manner in which tutoring services are offered, whether by the academic institution or privately by a third party, is not without its drawbacks.

In this regard, as an initial matter, the need for a tutor oftentimes arises suddenly and, in many instances, in reference to an impending examination. Yet the rigid hours of a university tutoring center may not accommodate the urgent and timely needs of such students. As well, for private, third party tutors, knowing which tutors are most suitable for providing effective tutoring for the topic at hand can be difficult, and in many ways, depends upon word of mouth recommendations. Yet, a tutor known to be effective for one student may be completely ineffective for another. Finally, a tutor known to be effective for one topic may be completely ineffective for another. Thus, on many occasions, the matching of student to tutor is a random exercise at best leaving the student without effective tutoring.

### BRIEF SUMMARY OF THE INVENTION

Embodiments of the present invention address deficiencies of the art in respect to tutor matching and provide a novel and non-obvious method, system and computer program product for tutor rating in brokered tutor matching. In an embodiment of the invention, a method for tutor rating for brokered tutor matching includes receiving from over a computer communications network in memory of a host computer, a tutoring request for tutoring services from a student registered for a selection of courses at an academic institution, the request specifying one of the courses, a time of tutoring and duration of tutoring. Thereafter, a set of tutors is identified, each having been registered in the host computer to perform tutoring in the specified one of the courses as having previously completed coursework in the specified one of the courses and having achieved a threshold grade in the specified one of the courses. A rating for each one of the tutors in the set is then retrieved and the student matched with a highest rated one of the tutors in the set. Finally, the matched tutor is assigned to provide the tutoring services at the time of tutoring.

In one aspect of the embodiment, the retrieved rating for a corresponding one of the tutors is an average of all ratings assigned to the corresponding one of the tutors by past students who had received tutoring from the corresponding one of the tutors. In another aspect of the embodiment, the retrieved rating for a corresponding one of the tutors is an average of all ratings assigned to the corresponding one of the tutors by past students who had received tutoring in the specified one of the courses from the corresponding one of the tutors. In yet another aspect of the embodiment, the retrieved rating for a corresponding one of the tutors is a weighted composition of a lower weighted average of all ratings assigned to the corresponding one of the tutors by past students who had received tutoring from the corresponding one of the tutors, in combination with a higher weighted average of all ratings assigned to the corresponding one of the tutors by past students who had received tutoring in the specified one of the courses from the corresponding one of the tutors. Finally, in even yet another aspect of the embodiment, the rating for a corresponding one of the tutors is a value computed based upon a differential between a grade of a past student who had received tutoring services from the corresponding one of the tutors prior to receiving the tutoring services and a grade of the past student after the past student had received the tutoring services from the corresponding one of the tutors.

In another embodiment of the invention, a data processing system is configured for classroom vacancy determination in brokered tutor matching. The system includes a host computing system that includes one or more computing servers, each with memory and at least one processor. The system also includes a multiplicity of communicative links with a corresponding multiplicity of remote computing devices over a computer communications network. The system yet further includes a database coupled to the host computing system, that includes multiple records, each corresponding to a different student, each of the records including a course listing of courses for which the different student is registered at an academic institution, a demographic profile of the different student and an indication of a number of credits available for use by the different student in procuring tutoring services. The database further includes a registry of different tutors able to provide tutoring services in connection with different academic topics.

Finally, the system includes a tutor matching module executing in memory of the host computing system. The module includes computer program instructions enabled during execution in the host computing system to receive from over a computer communications network in memory of a host computer, a tutoring request for tutoring services from a student registered for a selection of courses at an academic institution, the request specifying one of the courses, a time of tutoring and duration of tutoring. The program instructions further are enabled to identify a set of tutors each registered in the host computer to perform tutoring in the specified one of the courses as having previously completed coursework in the specified one of the courses and having achieved a threshold grade in the specified one of the courses. The program instructions yet further are enabled to retrieve a rating for each one of the tutors in the set and to match the student with a highest rated one of the tutors in the set. Finally, the program instructions are enabled to assign the matched tutor as a tutor providing the tutoring services at the time of tutoring.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for tutor rating for brokered tutor matching;

FIG. 2 is a schematic illustration of a data processing system configured for tutor rating for brokered tutor matching; and,

FIG. 3 is a flow chart illustrating a process for tutor rating for brokered tutor matching.

### DETAILED DESCRIPTION OF THE INVENTION

Embodiments of the invention provide for tutor rating for brokered tutor matching. In accordance with an embodiment of the invention, a request for tutor matching is received in a brokered tutor matching system. The request is received in connection with specified subject matter for which tutoring session is required, a specific time of the required tutoring and a particular duration of time required for the tutoring. In response to the request, a set of different tutors able to provide tutoring for the specific subject matter are retrieved and the list is filtered to include only those of the different tutors known to have completed corresponding coursework for the specified subject matter and to have received a threshold grade in the corresponding coursework. Amongst the filtered tutors, a tutor having received a highest rating computed from the ratings of previously tutored students is selected as a recommend match for the request and the selected tutor is assigned to the requesting student in response to the request.

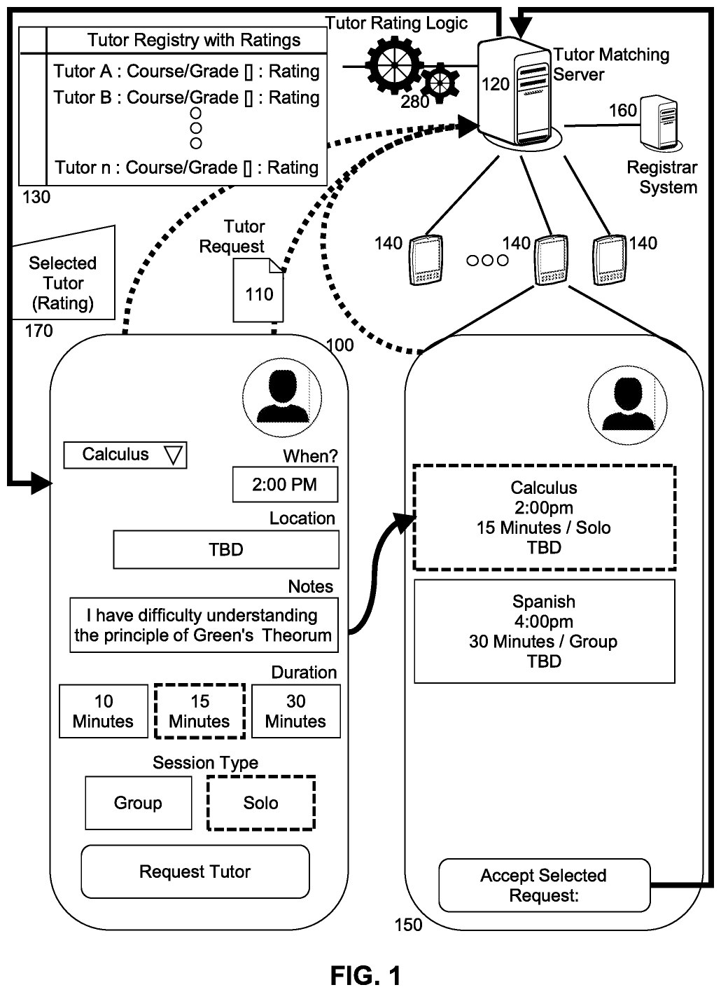

In further illustration, FIG. 1 pictorially shows a process for tutor rating for brokered tutor matching. As shown in FIG. 1, a student through user interface 100 to a tutor matching server 120 formulates a request 110 for tutoring services. The request 110 is formulated through the interaction by the student with different user interface controls of the user interface 100. In particular, and as a non-limiting example, FIG. 1 shows a user interface 100 including controls presenting a selectable list of courses for which the student has been contemporaneously registered as indicated by registrar system 160, and for which tutoring is requested, an input field into which a time for the tutoring session may be specified, a free-form text input field into which additional comments regarding the required tutoring services may be provided, a selection of tutoring session durations, a selection of tutoring session types, and a submit button responsive to which a tutor request 110 including the information provided in the user interface 100 is transmitted over a computer communications network to the tutor matching server 120.

The tutor matching server 120, upon receiving the tutor request 110, invokes tutor rating logic 180 to query tutor registry 130 in order to identify only those of the tutors who have completed coursework in the topic specified by the tutor request 110 and who have achieved a threshold grade in the topic specified by the tutor request 110. As it will be understood, the coursework and corresponding grades of the respective tutors of the registry 130 may be extracted by the tutor matching server 120 from the registrar system 160. In this regard, the threshold grade may be an equivalent to an “A” grade, by way of example. Thereafter, the tutor matching server 120 generates a request for tutoring for broadcasting to the mobile computing devices 140 of only those of the tutors specified by the tutor rating logic 180 who have completed the requisite coursework in the specified topic and who have achieved a threshold grade sufficient to demonstrate superior knowledge in the specified topic.

Each of the selected tutors receiving the broadcast request view the content of the broadcast request in a corresponding user interface 150. The user interface 150 of each corresponding one of the recipient tutors provides a listing of all tutoring requests broadcast to the corresponding one of the recipient tutors that has yet to be assigned to a particular one of the recipient tutors. Each entry in the listing is selectable and provides the pertinent details of the tutoring request such as the subject matter for which tutoring session is required, a time of occurrence of the tutoring session, and a duration of the tutoring session. The user interface 150 additionally includes an activatable submit button submitting the election by the corresponding one of the tutors to perform the requested tutoring services for the selected request in the listing.

The tutor matching server 120 then receives one or more different responses to the broadcast request and invokes tutor rating logic 180 to determine a rating for each of the tutors providing the responses to the broadcast request. The tutor providing a response known to have a highest rating is then assigned as the tutor for the student in a response 170 through user interface 100. As such, the tutor matching server establishes the tutoring session for the selected tutor and the student at the specified time. In this way, the most relevant tutor for the specified topic may be automatically proposed to the student without requiring the student to engage in a tedious manual process of locating a skilled and capable tutor for the specified topic based upon word of mouth or pure guesswork.

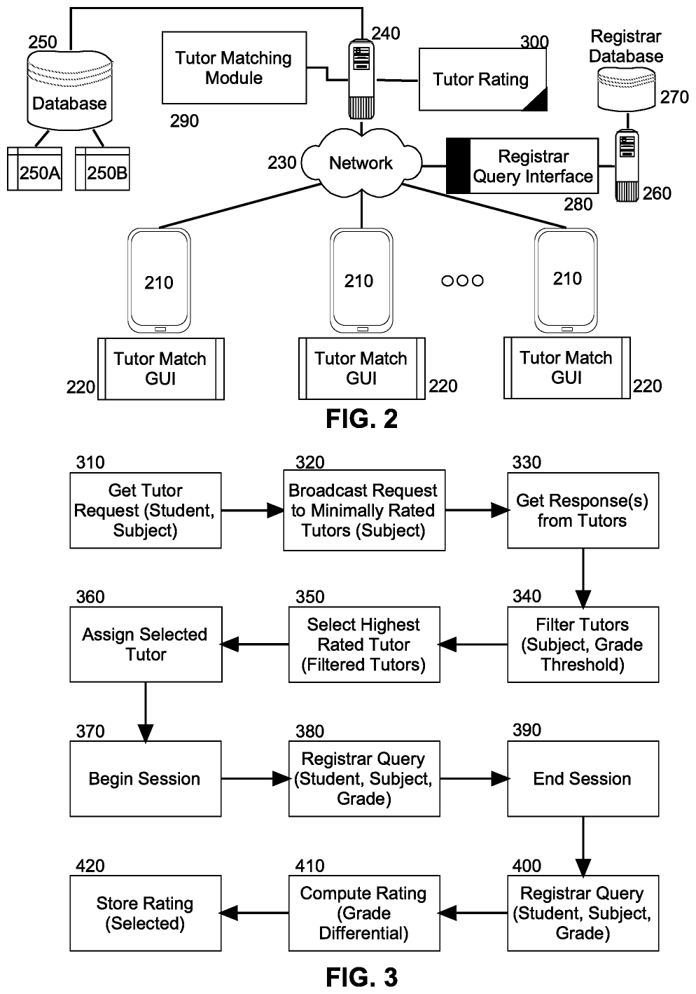

The process described in connection with FIG. 1 may be implemented in a computer data processing system. In further illustration, FIG. 2 schematically shows a data processing system configured for tutor rating for brokered tutor matching. The system includes a host computing server 240 including one or more computers, each with memory and at least one processor. The host computing server 240 is communicatively linked to different mobile devices 210 over computer communications network 230, each of the mobile devices 210 belonging either to a student in an academic institution, a tutor at the academic institution, or both.

The host computing server 240 includes a database 250 that may include one or more databases either locally present within the host computing server 240, or accessible remotely by the host computing server 240. The database 250 includes a tutor registry 250A and a student table 250B. The tutor registry 250A includes a listing of different tutors registered to perform tutoring services in connection with one or more academic topics, a grade achieved in a class corresponding to each academic topic, and a most recent rating applied to the corresponding tutor. The student table 250B includes a listing of different students registered to receive tutoring services. Of note, the student table 250B includes for each corresponding student, a set of courses for which the corresponding student is contemporaneously registered at the academic institution.

Importantly, a tutor matching module 290 executes in the memory of the host computing server 240. The tutor matching module 290 includes computer program instructions that during execution, receive through a tutor matching user interface 220 in a mobile device 210 of a tutor request for tutoring services in a specified academic topic of interest at a particular time and location for a specified duration of time. The program instructions during execution additionally locate within the tutor registry 250A, a selection of tutors able to perform the requested tutoring services based upon the completion by each of the tutors of a class corresponding to the specified academic topic for which the tutor received a minimum threshold grade indicated in the tutor registry 250A, such as an “A’.

The program instructions during execution even further broadcast to the selection of tutors, the tutor request for viewing in the user interface 220 of respective ones of the mobile devices 210 of the selection of tutors. Finally, the program instructions during execution receive one or more responses to the broadcast request from ones of the selection of tutors and retrieve for each responding one of the tutors, a corresponding rating. In this regard, the rating can be an average rating applied to each responding one of the tutors by all students having received tutoring services from the tutor irrespective of the academic topic, or the rating can be an average rating applied to each responding one of the tutors by only those students having received tutoring services from the tutor in the specified academic topic. Optionally, the rating can be a composition of both, with the average rating applied to each of the tutors by only those students having received tutoring services from the tutor in the specified academic topic being weighted more heavily and thus with greater emphasis, than the average rating applied irrespective of the academic topic. Based upon the rating, the ability of the tutors to respond to the request can be limited to only those tutors who at the time of the request enjoy a rating for the specified academic topic that exceeds a predetermined minimum value, and who at the time of the request also enjoy an average rating for all academic topics that exceeds a predetermined minimum value. Finally, the program instructions match a responding one of the tutors with the highest rating to the student issuing the request and upon completion of the tutoring session, transfer credits from the student to the tutor in accordance with a quoted rate for employing the assigned tutor for the tutoring session.

Of note, prior to the commencement of the requested tutoring session, the program instructions of the tutor rating module 300 access the registrar database 270 thorough a registrar query interface 280 to a server 260 in order to receive a contemporaneous grade in the course for the specified academic topic of the requesting student. Then, after the tutoring session has completed as between the matched tutor and student, the program instructions yet again issue a query to the registrar query interface 280 to again receive a newer grade in the course. Then, a rating is applied in the tutor registry 250A to the matched tutor that is based upon a differential between the contemporaneous grade prior to the tutoring session, and the new grade. In this regard, the greater the differential (indicating greater success), the better and thus the higher the rating that is applied to the matched tutor.

In even yet further illustration of a simple mode of operation of the tutor rating module 300, FIG. 3 is a flow chart illustrating a process for tutor rating for brokered tutor matching. Beginning in block 310, a tutor request is received from a student in respect to a specified academic topic. In block 320, the request is then broadcast to only those tutors known to have completed coursework in a course corresponding to the academic topic. Optionally, the tutors receiving the broadcast may be limited to only those tutors with an assigned rating for the course that is contemporaneously determined to be above a threshold value. As well, the tutors receiving the broadcast may be limited to only those tutors with a contemporaneous rating for all courses (an overall rating) that exceeds a threshold value. In block 330, one or more responses are received from the tutors receiving the broadcast request. In block 340, the responding tutors are then filtered to produce a listing of tutors who also have achieved a threshold grade in the course. In block 350, a highest rated one of the tutors amongst those in the listing is selected and in block 360, the selected tutor is assigned to the student as the tutor for the tutoring session.

In block 370, once the recommended tutor has been assigned to the tutoring session, the session may commence. As such, in block 380, the registrar database may be queried to retrieve a contemporaneous grade for the student in the course. In block 390, the tutoring session ends and in block 400, the registrar database is queried once again in order to retrieve an updated grade. Optionally, rather than querying the registrar database, the contemporaneous grade and updated grade may be provided manually by the student through the user interface to the tutor matching module. In any case, in block 410, a rating is computed based upon a grade differential as between the contemporaneous grade and the updated grade. Finally, in block 420, computed rating is applied to the tutor in the tutor registry.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A tutor rating method for brokered tutor matching the method comprising:
receiving from over a computer communications network in memory of a host computer, a tutoring request for tutoring services from a student registered for a selection of courses at an academic institution, the request specifying one of the courses, a time of tutoring and duration of tutoring;
identifying a set of tutors each registered in the host computer to perform tutoring in the specified one of the courses as having previously completed coursework in the specified one of the courses and having achieved a threshold grade in the specified one of the courses;
retrieving a rating for each one of the tutors in the set;
matching the student with a highest rated one of the tutors in the set;
assigning the matched tutor as a tutor providing the tutoring services at the time of tutoring.

2. The method of claim 1, wherein the retrieved rating for a corresponding one of the tutors is an average of all ratings assigned to the corresponding one of the tutors by past students who had received tutoring from the corresponding one of the tutors.

3. The method of claim 1, wherein the retrieved rating for a corresponding one of the tutors is an average of all ratings assigned to the corresponding one of the tutors by past students who had received tutoring in the specified one of the courses from the corresponding one of the tutors.

4. The method of claim 1, wherein the retrieved rating for a corresponding one of the tutors is a weighted composition of a lower weighted average of all ratings assigned to the corresponding one of the tutors by past students who had received tutoring from the corresponding one of the tutors, in combination with a higher weighted average of all ratings assigned to the corresponding one of the tutors by past students who had received tutoring in the specified one of the courses from the corresponding one of the tutors.

5. The method of claim 1, wherein the rating for a corresponding one of the tutors is a value computed based upon a differential between a grade of a past student who had received tutoring services from the corresponding one of the tutors prior to receiving the tutoring services and a grade of the past student after the past student had received the tutoring services from the corresponding one of the tutors.

6. A data processing system configured for classroom vacancy determination in brokered tutor matching, the system comprising:
a host computing system comprising one or more computing servers, each with memory and at least one processor, the system comprising a multiplicity of communicative links with a corresponding multiplicity of remote computing devices over a computer communications network;
a database coupled to the host computing system, the database comprising a multiplicity of records, each corresponding to a different student, each of the records comprising a course listing of courses for which the different student is registered at an academic institution, a demographic profile of the different student and an indication of a number of credits available for use by the different student in procuring tutoring services, the database further comprising a registry of different tutors able to provide tutoring services in connection with different academic topics;
a tutor matching module executing in memory of the host computing system, the module comprising computer program instructions enabled during execution in the host computing system to perform:
receiving from over a computer communications network in memory of a host computer, a tutoring request for tutoring services from a student registered for a selection of courses at an academic institution, the request specifying one of the courses, a time of tutoring and duration of tutoring;
identifying a set of tutors each registered in the host computer to perform tutoring in the specified one of the courses as having previously completed coursework in the specified one of the courses and having achieved a threshold grade in the specified one of the courses;
retrieving a rating for each one of the tutors in the set;
matching the student with a highest rated one of the tutors in the set;
assigning the matched tutor as a tutor providing the tutoring services at the time of tutoring.

7. The system of claim 6, wherein the retrieved rating for a corresponding one of the tutors is an average of all ratings assigned to the corresponding one of the tutors by past students who had received tutoring from the corresponding one of the tutors.

8. The system of claim 6, wherein the retrieved rating for a corresponding one of the tutors is an average of all ratings assigned to the corresponding one of the tutors by past students who had received tutoring in the specified one of the courses from the corresponding one of the tutors.

9. The system of claim 6, wherein the retrieved rating for a corresponding one of the tutors is a weighted composition of a lower weighted average of all ratings assigned to the corresponding one of the tutors by past students who had received tutoring from the corresponding one of the tutors, in combination with a higher weighted average of all ratings assigned to the corresponding one of the tutors by past students who had received tutoring in the specified one of the courses from the corresponding one of the tutors.

10. The system of claim 6, wherein the rating for a corresponding one of the tutors is a value computed based upon a differential between a grade of a past student who had received tutoring services from the corresponding one of the tutors prior to receiving the tutoring services and a grade of the past student after the past student had received the tutoring services from the corresponding one of the tutors.

11. A computer program product for tutor rating in brokered tutor matching, the computer program product including a computer readable storage medium having program instructions embodied therewith, the program instructions executable by a device to cause the device to perform a method including:
receiving from over a computer communications network in memory of a host computer, a tutoring request for tutoring services from a student registered for a selection of courses at an academic institution, the request specifying one of the courses, a time of tutoring and duration of tutoring;
identifying a set of tutors each registered in the host computer to perform tutoring in the specified one of the courses as having previously completed coursework in the specified one of the courses and having achieved a threshold grade in the specified one of the courses;
retrieving a rating for each one of the tutors in the set;
matching the student with a highest rated one of the tutors in the set;
assigning the matched tutor as a tutor providing the tutoring services at the time of tutoring.

12. The computer program product of claim 11, wherein the retrieved rating for a corresponding one of the tutors is an average of all ratings assigned to the corresponding one of the tutors by past students who had received tutoring from the corresponding one of the tutors.

13. The computer program product of claim 11, wherein the retrieved rating for a corresponding one of the tutors is an average of all ratings assigned to the corresponding one of the tutors by past students who had received tutoring in the specified one of the courses from the corresponding one of the tutors.

14. The computer program product of claim 11, wherein the retrieved rating for a corresponding one of the tutors is a weighted composition of a lower weighted average of all ratings assigned to the corresponding one of the tutors by past students who had received tutoring from the corresponding one of the tutors, in combination with a higher weighted average of all ratings assigned to the corresponding one of the tutors by past students who had received tutoring in the specified one of the courses from the corresponding one of the tutors.

15. The computer program product of claim 11, wherein the rating for a corresponding one of the tutors is a value computed based upon a differential between a grade of a past student who had received tutoring services from the corresponding one of the tutors prior to receiving the tutoring services and a grade of the past student after the past student had received the tutoring services from the corresponding one of the tutors.
